(19) United States
(12) Patent Application Publication
(10) Pub. No.: US 2017/0008219 A1
(43) Pub. Date: Jan. 12, 2017

(54) IMPRINTING APPARATUS, IMPRINTING METHOD, AND METHOD OF MANUFACTURING OBJECT

(71) Applicant: CANON KABUSHIKI KAISHA, Tokyo (JP)

(72) Inventor: Tosiya Asano, Utsunomiya-shi (JP)

(21) Appl. No.: 15/203,619

(22) Filed: Jul. 6, 2016

(30) Foreign Application Priority Data
Jul. 9, 2015 (JP) 2015-138159

(51) Int. Cl. B29C 59/02

(52) U.S. Cl. CPC B29C 59/02; B29L 2007/001

(57) ABSTRACT

An imprinting apparatus that forms a pattern on an imprint material by bringing the imprint material on a substrate and a mold into contact with each other includes a detecting unit that detects a force generated in at least one of the substrate and the mold when performing alignment of the substrate and the mold with each other in a state where the imprint material on the substrate and the mold are in contact with each other, the force being in a direction along contact surfaces of the mold and the imprint material and a control unit that obtains an amount of change in the force detected by the detecting unit and controls the alignment based on the amount of change.

### BACKGROUND OF THE INVENTION

Field of the Invention

The present invention relates to an imprinting apparatus, an imprinting method, and a method of manufacturing an object.

Description of the Related Art

An imprinting technique is a technique for forming a fine pattern on a substrate by using a mold on which a fine pattern has been formed. An example of such an imprinting technique is a photo-curing method. In an imprinting technique that employs the photo-curing method, first, a liquid resin serving as an imprint material is supplied to a shot position, which is an imprint region on a substrate. The resin is cured by radiating light onto the resin in a state where a pattern of a mold is pressed against the resin (in an imprinted state). By separating (releasing) the mold from the cured resin, the pattern of the mold is transferred onto the resin on the substrate.

In the case of manufacturing a semiconductor chip by using such an imprinting technique, when a mold is pressed against a resin on a substrate, precise alignment of the substrate and the mold with each other in an in-plane direction of the substrate needs to be performed. As a method of performing alignment of a substrate and a mold with each other in an imprinting apparatus, a so-called die-by-die system is known. In the die-by-die system, alignment of a substrate and a mold with each other is performed by detecting a mark formed on the mold and a mark formed on each shot of the substrate.

In Japanese Patent Laid-Open No. 2010-080714, a technique for improving overlay precision by matching the shape of a pattern formed on a substrate and the shape of a pattern formed on a mold to each other has been proposed. In the technique disclosed in Japanese Patent Laid-Open No. 2010-080714, a mold is deformed by a mold chuck, which holds the mold, in such a manner that a pattern of a substrate and a pattern of the mold match each other.

In addition, in Japanese Patent Laid-Open No. 2007-137051, a technique for performing alignment of a substrate and a mold with each other has been proposed. In the technique disclosed in Japanese Patent Laid-Open No. 2007-137051, when performing alignment of a substrate and a mold with each other in a state where the mold and a resin on the substrate are in contact with each other, adjustment of the positional relationship between the substrate and the mold is facilitated by reducing a force that presses the mold against the resin.

When a pattern of the mold is pressed against the resin, it is desired that a space between the substrate and the mold be sufficiently filled with the resin. However, when the space is not sufficiently filled with the resin, there is a possibility that the substrate and the mold may partially come into contact with each other. When a force acts on at least one of the mold and the substrate in a state where the substrate and the mold are in contact with each other, the mold and the substrate are deformed, and the overlay precision between the shape of a pattern formed on the substrate and the shape of a pattern formed on the mold deteriorates.

### SUMMARY OF THE INVENTION

The present invention is directed at an imprinting apparatus that is advantageous in terms of overlay precision.

An imprinting apparatus according to an aspect of the present invention is an imprinting apparatus that forms a pattern on an imprint material by bringing the imprint material on a substrate and a mold into contact with each other and includes a detecting unit that detects a force generated in at least one of the substrate and the mold when performing alignment of the substrate and the mold with each other in a state where the imprint material on the substrate and the mold are in contact with each other, the force being in a direction along contact surfaces of the mold and the imprint material and a control unit that obtains an amount of change in the force detected by the detecting unit and controls the alignment based on the amount of change.

Further features of the present invention will become apparent from the following description of exemplary embodiments with reference to the attached drawings.

### BRIEF DESCRIPTION OF THE DRAWINGS

FIG. 1 is a diagram illustrating a representative example of the configuration of an imprinting apparatus according to an embodiment of the present invention.

FIG. 2 is a flowchart illustrating an exemplary sequence of an alignment process according to the embodiment of the present invention.

FIG. 3 is diagram illustrating an example of a mechanical model of the imprinting apparatus according to the embodiment of the present invention.

FIG. 4 is a graph showing the relationship between a force F and a displacement amount X2 according to the embodiment of the present invention.

### DESCRIPTION OF THE EMBODIMENTS

An embodiment of the present invention will be described in detail below with reference to the drawings. The same members in the drawings are denoted by the same reference numerals, and repeated descriptions will be omitted.

### Embodiment

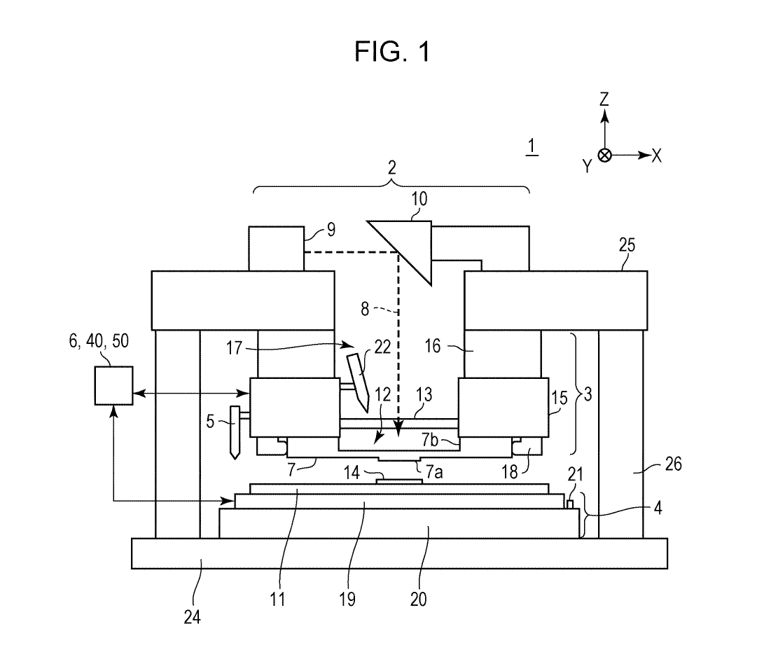

An imprinting apparatus according to an embodiment of the present invention will now be described with reference to FIG. 1. FIG. 1 is a diagram illustrating a representative example of the configuration of the imprinting apparatus according to the present embodiment. An imprinting apparatus 1 is a lithography apparatus that is used in the manufacture of devices such as semiconductor devices, which are objects. The imprinting apparatus 1 molds an imprint material (an uncured resin) on a substrate by using a mold in such a manner as to form a pattern on the substrate. The imprinting apparatus 1 employs a photo-curing method in the present embodiment. In the following description, a direction parallel to an optical axis of an irradiation system that irradiates the resin on the substrate with an ultraviolet ray will be defined as a Z-axis, and two directions that are perpendicular to each other in a plane perpendicular to the Z-axis are respectively defined as an X-axis and a Y-axis.

As illustrated in FIG. 1, the imprinting apparatus 1 includes an illuminating unit 2, a mold-holding mechanism (mold stage) 3, a substrate stage 4, a resin-supplying unit 5, a control unit 6, a magnification correction mechanism 18, an alignment measurement system 22, and a detecting unit 50. In addition, the imprinting apparatus 1 includes a base surface plate 24 on which the substrate stage 4 is to be placed, a bridge base 25 that fixes the mold-holding mechanism 3 in place, and columns 26 that are formed so as to extend from the base surface plate 24 and that support the bridge base 25. Furthermore, the imprinting apparatus 1 includes a mold-transport mechanism that transports a mold 7 to the imprinting apparatus 1 (mold-holding mechanism 3) from outside the imprinting apparatus 1 and a substrate-transport mechanism that transports a substrate 11 to the imprinting apparatus 1 (substrate stage 4) from outside the imprinting apparatus 1.

In an imprint process, the illuminating unit 2 radiates, via the mold 7, an ultraviolet ray (i.e., a light beam that cures the resin 14) 8 onto a resin 14 on the substrate 11. The illuminating unit 2 includes a light source 9 and an optical device 10 that adjusts the ultraviolet ray 8 radiated from the light source 9 to a light beam suitable for the imprint process. Since the photo-curing method is employed in the present embodiment, the imprinting apparatus 1 includes the illuminating unit 2. However, in the case of employing a heat-curing method, the imprinting apparatus 1 includes a heat source for curing a resin (a thermosetting resin) instead of the illuminating unit 2.

The mold 7 has a rectangular outer periphery shape, and a pattern (a concave-convex pattern such as a circuit pattern to be transferred onto the substrate 11) 7a that is three-dimensionally formed on a surface (a pattern surface) of the mold 7, the surface facing the substrate 11. The mold 7 is formed of a material that can transmit the ultraviolet ray 8, and an example of the material is a quartz.

The mold 7 has a cavity (recess) 7b that facilitates deformation of the mold 7 in a surface (an incident surface on which the ultraviolet ray 8 is to be incident) of the mold 7, the surface being opposite to the pattern surface. The cavity 7b has a circular planar shape. The thickness (depth) of the cavity 7b is set in accordance with the size or the material of the mold 7.

The cavity 7b is in communication with an opening 17 formed in the mold-holding mechanism 3, and a light transmission member 13 is disposed in the opening 17 so as to cause a space 12 surrounded by part of the opening 17 and the cavity 7b to be a hermetically-sealed space. The pressure in the space 12 is controlled by a pressure-regulating mechanism (not illustrated). For example, when the mold 7 is pressed against the resin 14 on the substrate 11, the pressure in the space 12 is set to be higher than an external pressure by the pressure-regulating mechanism, and the pattern 7a of the mold 7 is deformed in a convex manner with respect to the substrate 11. As a result, the mold 7 comes into contact with the resin 14 on the substrate 11 starting from a center portion of the pattern 7a, and thus, the probability that a gas (air) will be trapped between the pattern 7a and the resin 14 is reduced, so that the pattern 7a can be effectively filled with the resin 14.

The mold-holding mechanism (holding unit) 3 includes a mold chuck 15 that attracts and holds the mold 7 by a vacuum suction force or an electrostatic force and a mold-moving mechanism 16 that holds the mold chuck 15 and moves the mold 7 (mold chuck 15). Each of the mold chuck 15 and the mold-moving mechanism 16 has the opening 17 formed in a center portion (inner portion) thereof in such a manner as to allow the ultraviolet ray 8 from the illuminating unit 2 to be radiated onto the resin 14 on the substrate 11.

The magnification correction mechanism (deforming mechanism) 18 is disposed on the mold chuck 15 and corrects the shape of the pattern 7a of the mold 7 (i.e., deforms the pattern 7a) by applying a force (displacing force) to side surfaces of the mold 7 held by the mold chuck 15. For example, the magnification correction mechanism 18 includes a piezoelectric element, which expands and contracts due to a volume change thereof when a voltage is applied to the piezoelectric element, and is configured to apply pressure to a plurality of portions of the side surfaces of the mold 7. The magnification correction mechanism 18 matches the shape of the pattern 7a of the mold 7 to the shape of a shot region formed in the substrate 11 by deforming the pattern 7a of the mold 7.

However, a case may be assumed in which it is difficult to match the shape of the pattern 7a of the mold 7 to the shape of the shot region formed in the substrate 11 by using the magnification correction mechanism 18. In such a case, the shot region formed in the substrate 11 may also be deformed so as to bring the shape of the shot region formed in the substrate 11 close to the shape of the pattern 7a of the mold 7 (to reduce the difference in shape between the shot region and the pattern 7a). In order to deform the shot region formed in the substrate 11, for example, the substrate 11 may be heated to cause thermal deformation thereof.

The mold-moving mechanism 16 moves the mold 7 in the Z-axis direction in such a manner that pressing of the mold 7 against (imprinting the mold 7 onto) the resin 14 on the substrate 11 and separating (releasing) of the mold 7 from the resin 14 on the substrate 11 are selectively performed. Examples of an actuator that can be applied to the mold-moving mechanism 16 include a linear motor and an air cylinder. The mold-moving mechanism 16 may include a plurality of driving systems, such as a coarse-motion driving system and a fine-motion driving system, in order to perform positioning of the mold 7 with high precision. In addition, the mold-moving mechanism 16 may be capable of moving the mold 7 in the X-axis direction and the Y-axis direction as well as in the Z-axis direction. Furthermore, the mold-moving mechanism 16 may have a tilt function for adjusting the position of the mold 7 in a θ direction (rotation direction about the Z-axis) and the inclination of the mold 7. A position sensor, such as an encoder, may be attached to the mold-moving mechanism 16 such that a position-measurement unit 40 can measure the position of the mold 7 held by the mold chuck 15. Note that the position-measurement unit 40 may be included in the same device together with the control unit 6.

As in the present embodiment, imprinting and releasing the mold 7 in the imprinting apparatus 1 may be realized by moving the mold 7 in the Z-axis direction. However, imprinting and releasing the mold 7 in the imprinting apparatus 1 may be realized by moving the substrate 11 (substrate stage 4) in the Z-axis direction. Alternatively, imprinting and releasing the mold 7 in the imprinting apparatus 1 may be realized by relatively moving both the mold 7 and the substrate 11 in the Z-axis direction.

For example, the substrate 11 includes a single-crystal silicon substrate or a silicon-on-insulator (SOI) substrate. The resin 14 that is to be molded by the pattern 7a of the mold 7 is supplied (applied) to the substrate 11.

The substrate stage 4 is capable of moving while holding the substrate 11. When the mold 7 is pressed against the resin 14 on the substrate 11, alignment of the substrate 11 and the mold 7 with each other is performed by moving the substrate stage 4. The substrate stage 4 includes a substrate chuck 19 that attracts and holds the substrate 11 by a vacuum suction force or an electrostatic force and a substrate-moving mechanism (driving unit) 20 that is capable of moving in an XY plane while mechanically holding the substrate chuck 19. In addition, the substrate stage 4 has a reference mark 21 that is used when positioning the substrate stage 4.

Examples of an actuator that can be applied to the substrate-moving mechanism 20 include a linear motor and an air cylinder. The substrate-moving mechanism 20 may include a plurality of driving systems, such as a coarse-motion driving system and a fine-motion driving system, in order to perform positioning of the substrate 11 with high precision. In addition, the substrate-moving mechanism 20 may be capable of moving the substrate 11 in the Z-axis direction as well as in the X-axis direction and the Y-axis direction. Furthermore, the substrate-moving mechanism 20 may have a tilt function for adjusting the position of the substrate 11 in the θ direction (rotation direction about the Z-axis) and the inclination of the substrate 11. A position sensor, such as an encoder, may be attached to the substrate-moving mechanism 20 such that the position-measurement unit 40 can measure the position of the substrate 11 held by the substrate stage 4. Note that the position-measurement unit 40 may be included in the same device together with the control unit 6.

The resin-supplying unit 5 supplies the resin 14 to the substrate 11 on the basis of a supply-amount information item that is an information item indicating a supply amount of the resin 14, which is to be supplied to the substrate 11. In the present embodiment, the resin 14 is an ultraviolet-ray-curing resin having a property of being cured as a result of being irradiated with the ultraviolet ray 8. The resin 14 is selected in accordance with various conditions such as a process for manufacturing a semiconductor device. In addition, for example, the supply amount (i.e., the supply-amount information item) of the resin 14 that is to be supplied by the resin-supplying unit 5 is set in accordance with the thickness of a pattern of the resin 14 (the thickness of a remaining film) formed on the substrate 11, the density of the pattern of the resin 14, and the like.

The control unit 6 is formed of a computer that includes a CPU and a memory, and the control unit 6 performs overall control of the imprinting apparatus 1 in accordance with a program stored in the memory. The control unit 6 controls the operation and adjustment of each unit of the imprinting apparatus 1 and the like so as to control an imprint process for forming a pattern on a substrate. The control unit 6 may be formed integrally with (may be disposed in a common housing together with) the other units of the imprinting apparatus 1 or may be formed so as to be a different unit from the other units of the imprinting apparatus 1 (may be disposed in a housing different from the housing in which the other units of the imprinting apparatus 1 are disposed). In addition, the control unit 6 may be formed of a plurality of computers.

The alignment measurement system (measuring unit) 22 measures the positional deviation between an alignment mark formed on the substrate 11 and an alignment mark formed on the mold 7 in the X-axis direction and the Y-axis direction. The control unit 6 adjusts the position of the substrate stage 4 (moves the substrate stage 4) on the basis of the positional deviation measured by the alignment measurement system 22 in such a manner that the position of the mold 7 and the position of the substrate 11 are aligned with each other. The alignment measurement system 22 can also measure the shape of the pattern 7a of the mold 7 and the shapes of shot regions formed in the substrate 11. Thus, the alignment measurement system 22 also functions as a measuring unit that measures an alignment state between one of the shot regions of the substrate 11 that is to be subjected to an imprint process and the pattern 7a of the mold 7. In the present embodiment, the alignment measurement system 22 measures a difference in shape between the pattern 7a of the mold 7 and one of the shot regions formed in the substrate 11.

The detecting unit 50 detects a force F that acts on at least one of the mold 7 and the substrate 11 when aligning the position of the mold 7 and the position of the substrate 11 with each other in a state where the mold 7 and the resin 14 on the substrate 11 are in contact with each other. Here, the force F is a force in a direction along contact surfaces of the mold 7 and the resin 14. Note that the detecting unit 50 may be formed to be the same as the control unit 6. The contact surfaces are surfaces that are parallel to the pattern surface of the mold 7 and are surfaces that pass through the lowermost surface of the pattern surface in a state where the mold 7 and the resin 14 are in contact with each other.

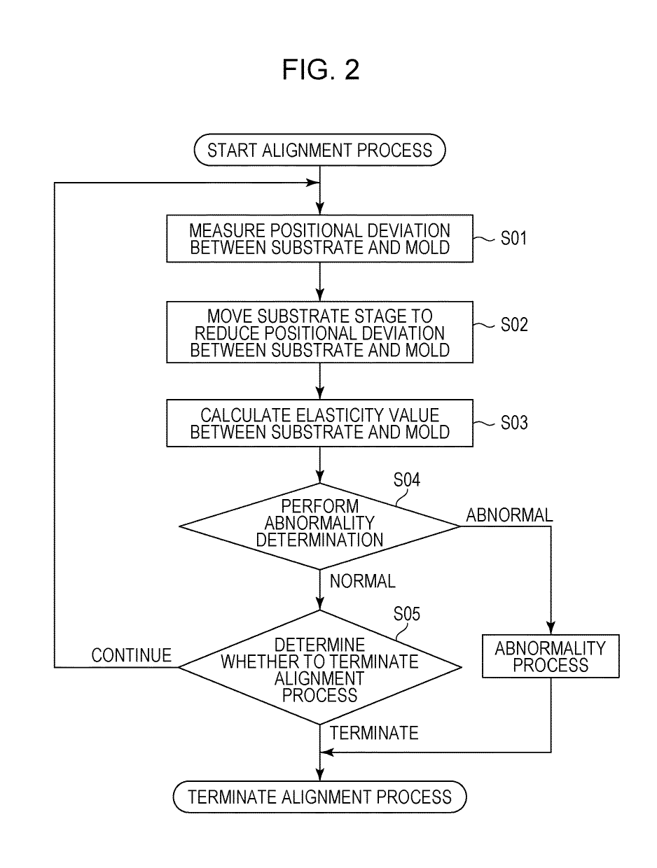

FIG. 2 is a flowchart illustrating an exemplary sequence of an alignment process according to the present embodiment. FIG. 2 illustrates one of the functions of the control unit 6, which performs overall control of the imprinting apparatus 1, the function being a sequence control of an alignment process that employs a die-by-die system and that is performed on one shot region. The alignment process will now be described with reference to FIG. 2. The alignment process is started in a state where the space between the mold 7 and the substrate 11 is filled with the resin 14 by lowering the mold 7 in the Z-axis direction to the resin 14, which has been applied to one of the shot regions of the substrate 11, by using the mold-moving mechanism 16.

In step S01, the positional deviation between the substrate 11 and the mold 7 is detected. The amount of deviation between relative positions of the substrate 11 and the mold 7 in an in-plane direction of a plane in which the substrate 11 and the mold 7 are in contact with each other is measured by the alignment measurement system 22.

In step S02, the substrate stage 4 is moved so as to reduce the positional deviation between the substrate 11 and the mold 7. The position of the substrate stage 4 is moved in the X-axis direction and the Y-axis direction in order to reduce the positional deviation between the substrate 11 and the mold 7. Alternatively, the position of the mold-moving mechanism 16 may be moved in the X-axis direction and the Y-axis direction in order to reduce the positional deviation between the substrate 11 and the mold 7.

In step S03, the value of elasticity between the substrate 11 and the mold 7 is calculated. Here, the value of elasticity between the substrate 11 and the mold 7 refers to the ratio of the amount of change in the force F to displacement amounts of the relative positions of the substrate 11 and the mold 7. The control unit 6 calculates the value of elasticity between the substrate 11 and the mold 7 from the force F generated in at least one of the mold 7 and the substrate 11 and the amounts of changes in the relative positions of the substrate 11 and the mold 7. Details of a method of calculating the value of elasticity will be described later.

In step S04, abnormality determination of a calculated elasticity value is performed. The control unit 6 compares a predetermined threshold and the elasticity value, and when the elasticity value is larger than the threshold, the control unit 6 determines that the elasticity value is abnormal. A process to be performed when the control unit 6 has determined that an elasticity value is abnormal will be described later.

In step S05, it is determined whether to terminate the alignment process. The control unit 6 determines whether the positional deviation between the mold 7 and the substrate 11 has been eliminated. The control unit 6 compares a positional deviation amount that has been detected and a predetermined threshold, and when the positional deviation amount has become further smaller than the threshold, the control unit 6 determines that the alignment process is to be terminated. In addition, the control unit 6 may determine that the alignment process is to be terminated when the elapsed time from the beginning of the alignment process has become larger than a predetermined threshold.

Once the alignment process has been started, steps S01 to S05 are repeatedly performed until the alignment process is terminated. After the alignment process has been terminated, the illuminating unit 2 radiates the ultraviolet ray 8 so as to cure the resin 14, and the mold-moving mechanism 16 is moved upward in such a manner that the mold 7 is released from the substrate 11. All of the shot regions in the substrate 11 are sequentially subjected to the imprint process. After all of the shot regions have undergone the imprint process, the substrate 11 is collected by a substrate-replacing hand (not illustrated), and a new substrate 11 is mounted on the substrate stage 4 and undergoes the imprint process in a similar manner to the above.

When it is determined that an elasticity value is abnormal in step S04, an abnormality process is performed. For example, in the abnormality process, the alignment process is cancelled. Then, the resin 14 is cured, and the mold 7 is released from the substrate 11 by moving upward the mold-moving mechanism 16. Subsequently, the imprint process is performed on the next shot region.

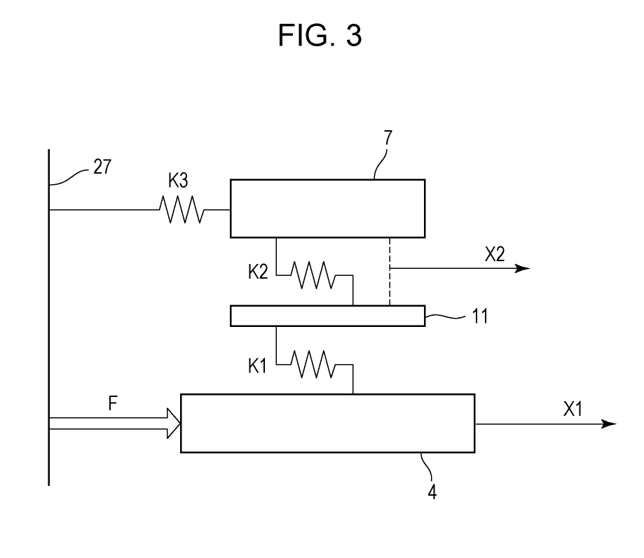

Calculation for the value of elasticity between the substrate 11 and the mold 7 performed in step S03 will now be described. FIG. 3 illustrates a mechanical model of the imprinting apparatus 1 in the X-axis direction. Note that a mechanical model of the imprinting apparatus 1 in the Y-axis direction can be illustrated in a similar manner to the mechanical model in FIG. 3. Here, the base surface plate 24, the bridge base 25, and the columns 26 are considered as one rigid body, that is, a main body 27 of the imprinting apparatus 1, and this main body 27 functions as a reference in the mechanical model. The substrate stage 4 receives the force F in the X-axis direction from the actuator of the substrate-moving mechanism 20, and a reaction force of the force F is received by the main body 27. A displacement amount X1 of the substrate stage 4 in the X-axis direction is measured by a measuring device (not illustrated) while the main body 27 functions as a reference. The substrate 11 is mounted on the substrate stage 4 via the substrate chuck 19, and the point of the substrate stage 4 to which the force F is applied and the substrate 11 are spaced apart from each other. An elasticity value K1 is a structural elasticity value of the substrate stage 4 from the point to which the force F is applied to the substrate 11. The mold 7 is caused to be supported on the main body 27 by the mold-moving mechanism 16, and the elasticity value of the structure of the mold-moving mechanism 16 is set to be an elasticity value K3 between the main body 27 and the mold 7.

When the alignment process is performed, the space between the substrate 11 and the mold 7 is filled with the resin 14, and the resin 14 has an elasticity value K2. In practice, a viscous force depending on relative speeds of the substrate 11 and the mold 7 acts on the resin 14. However, in order to make the following description simple, such a viscous force will be ignored so as to consider a static balance. The displacement amount X2 denotes the relative positions of the substrate 11 and the mold 7. The displacement amount X2 may be detected by the alignment measurement system 22 or may be obtained by measuring the positions of the mold 7 and the substrate 11 by using a measuring device (not illustrated). Three springs respectively having the elasticity value K1, the elasticity value K2, and the elasticity value K3 act as serial springs between the main body 27 and the substrate stage 4. In other words, the displacement amount X2 when the force F is applied is inversely proportional to the elasticity value K2. Here, the force F can be determined to be a force (thrust) that is applied to the substrate stage 4 when the relative positions of the substrate 11 and the mold 7 are changed by moving the substrate stage 4. The force F is a control force that is calculated by the control unit 6 and that is to be applied to the substrate stage 4, and the force F can be obtained as a command value from the control unit 6. In addition, the force applied to the substrate stage 4 can be obtained from the value of the current supplied to a linear motor that is applied as the actuator (not illustrated) of the substrate stage 4.

The force F may be determined to be a force that is applied to the mold-holding mechanism 3 (not illustrated), which is mounted in the mold-moving mechanism 16 and which holds the mold 7, when the relative positions of the substrate 11 and the mold 7 are changed by moving the mold-holding mechanism 3. The force applied to the mold-holding mechanism 3 can obtain the force F on the basis of the value of the current supplied to a linear motor that is applied as the actuator of the mold-moving mechanism 16.

In addition, the force F may be determined to be a force that is applied to the mold 7 by the magnification correction mechanism 18 (not illustrated) of the mold 7 in order to deform the pattern 7a of the mold 7. A force that is applied by the mold 7 and received by the magnification correction mechanism 18 can be obtained from the value of the current supplied to the piezoelectric element included in the magnification correction mechanism 18.

As described above, the displacement amount X2 is also an obtainable value that is detected by the alignment measurement system 22 or the like. Thus, the elasticity value K2 can be obtained from the force F and the displacement amount X2, which are both obtainable.

The elasticity value K2 is usually much smaller than the elasticity value K1 and the elasticity value K3, and the displacement amount X2 is generated by a slight force F. In other words, the relative positions of the substrate 11 and the mold 7 can be adjusted by a slight force. However, in the case where an abnormality has occurred between the substrate 11 and the mold 7, the elasticity value K2 is a large value, and only a small displacement amount X2 will be generated even if the force F is exerted. As a result, the positional deviation between the substrate 11 and the mold 7 cannot be eliminated. If the alignment process is continued in this state, in order to allow the control unit 6 to control the substrate stage 4, a large force F will be exerted.

Some of the reasons why this problem occurs are as follows: the substrate 11 and the mold 7 are in contact with each other, there is an area filled with the resin 14 that is extremely thin, very small foreign substances are trapped between the mold 7 and the substrate 11, a portion of the mold 7 corresponding to one of the shot regions is superposed with part of the resin 14 protruding out from another shot region adjacent to the one shot region, and the like.

In the abnormality determination in step S04, the elasticity value K2 is compared with the predetermined threshold, and when the elasticity value K2 exceeds the threshold, it is determined that the elasticity value K2 is abnormal. For example, the threshold is set to be 10 times larger than an experimental value of the elasticity value K2 in a state where the space between the substrate 11 and the mold 7 is properly filled with the resin 14. In addition, as will be described later, the threshold may be changed in accordance with the type of the resin 14 or the positions of the shot regions on the substrate 11. When an abnormal value has been determined in step S04, the alignment process is cancelled. Then, the resin 14 is cured, and the mold 7 is released from the substrate 11 by moving upward the mold-moving mechanism 16. Subsequently, the imprint process is performed on the next shot region. When an abnormality has occurred in one of the shot regions, it is very likely that other abnormalities occur in the other shot regions, and thus, the imprint process for the substrate 11 may be immediately cancelled without performing the imprint process on the next shot region. When abnormal values have been determined in a certain number of continuous shot regions, it is very likely that other abnormalities occur in the subsequent shot regions, and thus, the imprint process for the substrate 11 may be cancelled without performing the imprint process on the subsequent shot regions.

When calculating the elasticity value K2 between the substrate 11 and the mold 7 in step S03, since the elasticity value K2 can be calculated even if the force F is small, the abnormality determination can be performed while the force F is still small, and an abnormality occurred between the substrate 11 and the mold 7 can be detected at an early stage.

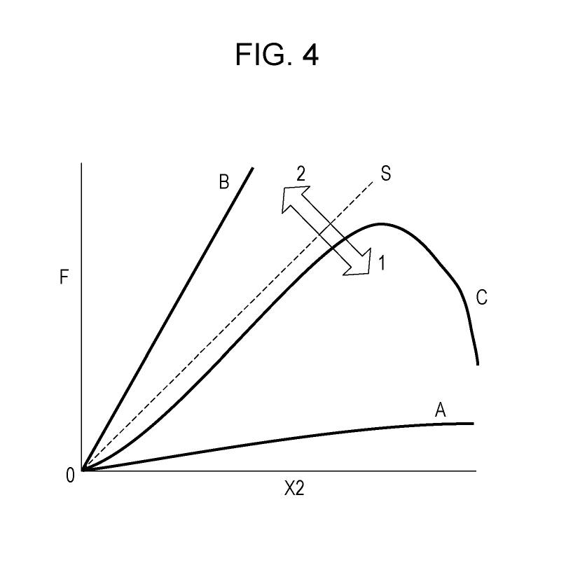

FIG. 4 is a graph showing the relationship between the force F and the displacement amount X2 according to the present embodiment. When the horizontal axis and the vertical axis represent the displacement amount X2 and the force F, respectively, inclination corresponds to the elasticity value K2. A straight line S is a straight line of a threshold inclination of the elasticity value K2. In the abnormality determination performed in step S04, a data item that is plotted in a region 1, in which the inclination of the data item is smaller than the inclination of the straight line S, is determined as normal, and a data item that is plotted in a region 2, in which the inclination of the data item is larger than the inclination of the straight line S, is determined as abnormal. A data item A is an example of a normal data item and the inclination of the data item A is smaller than the threshold. A data item B is an example of an abnormal data item and the inclination of the data item B is larger than the threshold. Since the abnormality determination is performed by using the elasticity value K2, that is, the inclination in the data plot of FIG. 4, the determination can be performed while the force F is still small compared with the case where an abnormality determination is performed by setting a threshold of the magnitude of the force F. A data item C represents a case where a momentarily-large force F is generated due to the moving speed of the substrate stage 4 during an alignment process even though the space between the substrate 11 and the mold 7 is properly filled with the resin 14. Although there is a possibility that a false determination may be made by using only the magnitude of the force F, a normal determination can be made by using the elasticity value K2. Note that, although FIG. 4 only shows the cases where the displacement amount X2 is a positive value for simplification of the graph, the abnormality determination can also be performed in a similar manner to the above when the displacement amount X2 is a negative value.

There is another method of calculating the elasticity value K2 other than the methods using the force F and the displacement amount X2. The elasticity values K1 and K3 can be obtained by performing a structural calculation or by conducting a measurement experiment. As illustrated in FIG. 3, the displacement amount X1 is equal to the sum total of the displacement amounts of the three springs respectively having the elasticity value K1, the elasticity value K2, and the elasticity value K3. In addition, since the three springs act as serial springs, an elasticity value K that is the sum of the reciprocals of the elasticity values K1, K2, and K3 can be calculated as the ratio of the amount of change in the force F to a displacement amount of the position of the substrate 11. Accordingly, the elasticity value K2 can be calculated from the force F, the elasticity value K1, the elasticity value K3, and the displacement amount X1. In this case, an abnormality determination may be performed by comparing the elasticity value K2 and the threshold as described above or may be performed by setting a threshold for the elasticity value K and then comparing the elasticity value K and the threshold. For example, when calculating the displacement amount X2 by using the alignment measurement system 22, it may sometimes take a long time to perform the calculation due to the computational effort required for image processing and the like. On the other hand, the force F is a command value from the control unit 6, and thus, the force F can be obtained without a time delay. Thus, deviation may sometimes occur between the timing at which the force F is obtained and the timing at which the displacement amount X2 is obtained, and this deviation may sometimes affect the calculation of the elasticity value K2. In addition, there is a case where an SN ratio of the displacement amount X2 obtained by the alignment measurement system 22 is low depending on the state of the alignment mark, and similarly, there is a case where an SN ratio of a calculated value of the elasticity value K2 is low. In these cases, as described above, the method using the displacement amount X1 is more effective than the method of using the displacement amount X2. Which method is best depends on the conditions under which an imprint operation is performed, and thus, one of the methods may be selected by comparing the displacement amounts X1 and X2.

Values of the elasticity value K2 that are calculated one after another over time may vary. Since there is a case where a false determination is made by using a momentary value, values the variations of which have been reduced by performing a commonly known statistical process, such as a smoothing process, may be used.

The positional deviation between the mold 7 and the substrate 11 may be eliminated by providing a mechanism that moves the mold 7. In this case, the elasticity value K3 in FIG. 3 can be replaced with a force that causes the mold 7 to move in the X-axis direction. Note that the force that causes the mold 7 to move in the X-axis direction is in an equal relationship with the force F in FIG. 3.

Since the elasticity value K2 of the resin 14 varies depending on the type of the resin 14, the thickness of the resin 14 between the substrate 11 and the mold 7, and the like, a threshold used in an abnormality determination may be changeable in accordance with these conditions. A portion of the mold 7 may sometimes be out of the substrate 11 in one of the shot regions in a peripheral portion of the substrate 11. In this state, different elasticity values may sometimes be obtained compared with in one of the shot regions in a center portion of the substrate 11 even in a normal state where the substrate 11 and the mold 7 are not in contact with each other and where foreign substances are not trapped between the substrate 11 and the mold 7. Consequently, the threshold for the center portion of the substrate 11 and the threshold for the peripheral portion of the substrate 11 may be different from each other. In addition, there is a case where the thickness of the resin 14 between the substrate 11 and the mold 7 varies depending on an imprint position on the substrate 11. Thus, the threshold may be changeable in accordance with the imprint position on the substrate 11. Note that an optimum value of the threshold may be obtained by conducting an experiment by changing the type and thickness of the resin 14, the imprint position on the substrate 11, and the like to various values or may be obtained by a computer simulation using a technique such as a finite element method.

Programming an operation for changing a threshold and an operation for selecting a calculation method for the elasticity value K2 beforehand enables the control unit 6 to automatically perform these operations. However, when an experimental imprint operation is performed during an adjustment stage of the imprinting apparatus 1 or the like, there is a case where the imprinting apparatus 1 shows an unexpected behavior. Calculation results of the elasticity value K2 and the like may be displayed on a console screen of the imprinting apparatus 1 so that an operator can input methods of calculating thresholds and elasticity values to the imprinting apparatus 1 and can change these methods at any time.

Although the ratio of the amount of change in the force F to the displacement amounts X2 of the substrate 11 and the mold 7 is used as a reference value used in the abnormality determination performed by the control unit 6 in step S04, the ratio of the amount of change in the force F to the time taken to change the position of the substrate 11 may be used as the reference value. When the magnitude of the force F rapidly increases for a short time, it can be determined that there is an abnormality. In step S03, the control unit 6 measures the time taken from the start to the end of an alignment process. In addition, the control unit 6 obtains the force F for each unit of time. The force F is obtained by the above-described method. Then, the control unit 6 obtains the ratio of the amount of change in the force F to the time taken to change the position of the substrate 11, and when the ratio of the amount of change exceeds a threshold, it is determined that there is an abnormality. The processes to be performed after step S04 are similar to those described above. Note that examples of the unit of time include 1 second, 0.1 seconds, and 0.01 seconds, and the unit of time may be set in accordance with the processing ability of the control unit 6. In addition, similar to the above-described case, the ratio of the amount of change may also vary, and thus, values the variations of which have been reduced by performing a commonly known statistical process, such as a smoothing process, may be used.

Therefore, according to the imprinting apparatus 1 of the present embodiment, the influence of a force that acts on at least one of the mold 7 and the substrate 11 can be reduced, and the overlay precision can be improved.

### (Method of Manufacturing Object)

A method of manufacturing an object such as, for example, a device (a semiconductor device, a magnetic storage medium, a liquid crystal display device, or the like), a color filter, or a hard disk will now be described. The manufacturing method includes a step of forming a pattern on a substrate (a wafer, a glass plate, a film substrate, or the like) by using an imprinting apparatus. The manufacturing method further includes a step of processing a substrate on which a pattern has been formed. The processing step may include a step of removing a remaining film of the pattern. In addition, the processing step may include another commonly known step such as a step of etching a substrate by using the pattern as a mask. The method of manufacturing an object according to the present embodiment is more advantageous than that of the related art in terms of at least one of the performance of an object, the quality of an object, the productivity, and the manufacturing costs.

According to the present invention, an imprinting apparatus that is advantageous in terms of overlay precision can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-138159 filed Jul. 9, 2015, which is hereby incorporated by reference herein in its entirety.

What is claimed is:

1. An imprinting apparatus that forms a pattern on an imprint material by bringing the imprint material on a substrate and a mold into contact with each other, the imprinting apparatus comprising:
a detecting unit that detects a force generated in at least one of the substrate and the mold when performing alignment of the substrate and the mold with each other in a state where the imprint material on the substrate and the mold are in contact with each other, the force being in a direction along contact surfaces of the mold and the imprint material; and
a control unit that obtains an amount of change in the force detected by the detecting unit and controls the alignment based on the amount of change.

2. The imprinting apparatus according to claim 1,
wherein the control unit obtains a ratio of an amount of change in the force to a displacement amount obtained when relative positions of the mold and the substrate are changed and controls the alignment based on the obtained ratio.

3. The imprinting apparatus according to claim 2, further comprising:
a measuring unit that measures an alignment mark formed on the substrate and an alignment mark formed on the mold,
wherein the measuring unit measures the displacement amount.

4. The imprinting apparatus according to claim 2, further comprising:
a position-measurement unit that measures a position of the substrate and a position of the mold,
wherein the position-measurement unit measures the displacement amount.

5. The imprinting apparatus according to claim 1,
wherein the control unit obtains a ratio of an amount of change in the force to a displacement amount obtained when a position of the substrate is changed and controls the alignment based on the obtained ratio.

6. The imprinting apparatus according to claim 5, further comprising:
a position-measurement unit that measures the position of the substrate,
wherein the position-measurement unit measures the position.

7. The imprinting apparatus according to claim 1,
wherein the control unit obtains a ratio of an amount of change in the force to a time taken to change a position of the substrate and controls the alignment based on the obtained ratio.

8. The imprinting apparatus according to claim 1, further comprising:
a substrate stage that holds the substrate; and
a driving unit that moves the substrate stage,
wherein the detecting unit detects the force based on a thrust of the driving unit.

9. The imprinting apparatus according to claim 1, further comprising:
a holding unit that holds the mold,
wherein the detecting unit detects the force based on a force that acts on the holding unit.

10. The imprinting apparatus according to claim 1, further comprising:
a deforming mechanism that causes the mold to deform by applying a force to the mold,
wherein the detecting unit detects the force based on the force applied to the mold by the deforming mechanism.

11. The imprinting apparatus according to claim 2,
wherein the control unit compares the obtained ratio and a threshold and cancels the alignment when the obtained ratio exceeds the threshold.

12. The imprinting apparatus according to claim 11,
wherein the control unit compares the ratio of the amount of change that has undergone a statistical process and the threshold.

13. The imprinting apparatus according to claim 11,
wherein the control unit changes the threshold in accordance with a type of the imprint material between the substrate and the mold.

14. The imprinting apparatus according to claim 11,
wherein the control unit changes the threshold in accordance with a thickness of the imprint material between the substrate and the mold.

15. The imprinting apparatus according to claim 11,
wherein the control unit changes the threshold in accordance with a position of a shot region in the substrate.

16. An imprinting method in which a pattern is formed on an imprint material by bringing the imprint material on a substrate and a mold into contact with each other, the imprinting method comprising:
detecting a force generated in at least one of the substrate and the mold when performing alignment of the substrate and the mold with each other in a state where the imprint material on the substrate and the mold are in contact with each other, the force being in a direction along contact surfaces of the mold and the imprint material; and
obtaining an amount of change in the force, which has been detected in the detecting of the force, and controlling the alignment based on the amount of change.

17. A method of manufacturing an object, the method comprising:
forming a pattern on a substrate by using an imprinting apparatus; and
processing the substrate, on which the pattern has been formed in the forming of the pattern,
wherein the imprinting apparatus is an imprinting apparatus that forms a pattern on an imprint material by bringing the imprint material on a substrate and a mold into contact with each other, and
wherein the imprinting apparatus includes
a detecting unit that detects a force generated in at least one of the substrate and the mold when performing alignment of the substrate and the mold with each other in a state where the imprint material on the substrate and the mold are in contact with each other, the force being in a direction along contact surfaces of the mold and the imprint material and
a control unit that obtains an amount of change in the force detected by the detecting unit and controls the alignment based on the amount of change.
